(19) United States
(12) Patent Application Publication
(10) Pub. No.: US 2021/0395066 A1
(43) Pub. Date: Dec. 23, 2021

(54) CONTACTLESS WATER DISPENSER

(71) Applicant: NINGBO AQUAWORLD ELECTRIC MANUFACTURE CO.,LTD., Beilun (CN)

(72) Inventors: Genlong HU, Ningbo (CN); Jianzhou XUE, Ningbo (CN); Shengzhi QIAO, Shaanxi Province (CN)

(21) Appl. No.: 16/996,380

(22) Filed: Aug. 18, 2020

(30) Foreign Application Priority Data
Jun. 22, 2020 (CN) 202010573921.2

(51) Int. Cl. B67D 1/00; G01S 17/04

(52) U.S. Cl. CPC B67D 1/0014; G01S 17/04; B67D 1/0004

(57) ABSTRACT

The present invention discloses a contactless water dispenser, including a housing, and a water receiving pipe, a water tank, and a water outlet pipe that are disposed in the housing. The water tank receives external drinking water through the water receiving pipe and performs discharging through the water outlet pipe, and a contactless triggering portion is disposed at a top portion of the housing, and the contactless triggering portion that can an external instruction at a distance is disposed on a connecting seat, so that a user is prevented from directly coming into contact with a trigger, to prevent transmission of bacteria and viruses, thereby improving usage experience.

### TECHNICAL FIELD

The present invention relates to the field of home appliances, and specifically, to a water dispenser.

### BACKGROUND ART

Existing water dispensers all need to be controlled and operated by users by coming into contact with or pressing a trigger, and therefore, have stable control performance. However, in public places, the trigger of the water dispenser becomes a medium for transmission of bacteria and viruses due to direct contact with relatively many people, thereby leading to human-to-human transmission of viruses and bacteria, and affecting health of users.

### SUMMARY

To overcome disadvantages of the prior art, the present invention provides a contactless water dispenser, where an instruction of a user is obtained at a distance by disposing a contactless triggering portion on a trigger, thereby effectively preventing transmission of viruses and bacteria caused by contact between a surface of a housing and different users, and ensuring health of users.

The present invention is implemented in the following manners: A contactless water dispenser is provided, including a housing, and a water receiving pipe, a water tank, and a water outlet pipe that are disposed in the housing. The water tank receives external drinking water through the water receiving pipe and performs discharging through the water outlet pipe, and a contactless triggering portion is disposed at a top portion of the housing, so that the contactless triggering portion receives an external instruction at a distance and triggers implementation of a corresponding operation. A contactless triggering portion that can receive the external instruction at a distance is disposed on a connecting seat, so that a user may control running of the water dispenser at a distance without coming into contact with the water dispenser. The user is prevented from directly coming into contact with a trigger to prevent transmission of bacteria and viruses, and health of the user is ensured by blocking a transmission route of bacteria and viruses, thereby improving usage experience.

Preferably, the contactless triggering portion includes a connecting seat and an infrared assembly exposed on a top surface of the connecting seat, a sensing region corresponding to the infrared assembly is disposed above the connecting seat, and the infrared assembly senses a moving path of a detected object in the sensing region and triggers implementation of a corresponding operation. The infrared assembly that can sense movement of the detected object in the sensing region is disposed on the connecting seat, and the user moves a limb in the sensing region to control running of the water dispenser, thereby effectively blocking a transmission route of bacteria and viruses, and ensuring health of the user.

Preferably, the connecting seat is provided with a mounting hole that is vertically through, and the infrared assembly is mounted on a bottom surface of the connecting seat from bottom to top and is exposed through the mounting hole. The mounting hole is provided on the connecting seat in a through manner, not only to provide a mounting space for the infrared assembly, but also to limit the infrared assembly, thereby preventing the infrared assembly from failing to sense movement of the detected object in the sensing region due to deviation, and ensuring triggering stability.

Preferably, the infrared assembly includes a fixed connecting ring, and after being mounted in place, the fixed connecting ring is lapped from bottom to top on a periphery of a lower port of the mounting hole and is fixedly connected by using a fastener. The fixed connecting ring not only plays a role of fixedly connecting the infrared assembly to the connecting seat, but also prevents the infrared assembly from being damaged due to being excessively inserted into the mounting hole and impacting the shield. After being mounted in place, the fixed connecting ring is fixedly connected under the connecting seat by using the fastener

Preferably, an upper port of the mounting hole is covered with a transparent shield, and after being mounted in place, the shield covers and blocks the upper port of the mounting hole. The shield does not affect scattering of infrared rays, but plays a role of covering and blocking the upper port of the mounting hole, thereby preventing the infrared assembly from a failure due to contact with an external foreign object.

Preferably, the infrared assembly includes an infrared transmitting piece and an infrared receiving piece, infrared rays generated by the infrared transmitting piece passes through a mounting hole and is scattered to the sensing region, and is received by the infrared receiving piece after being reflected by the detected object, so that the infrared assembly is triggered. The infrared transmitting piece is configured to transmit infrared rays, the infrared receiving piece is configured to receive infrared rays reflected back, and the infrared rays are irradiated on the detected object and are reflected, to form a basis for triggering the infrared assembly.

Preferably, the infrared assembly is located in the middle of a bottom surface of the sensing region, a height of the sensing region is H, and 20 cm≤H≤40 cm. The infrared rays are evenly scattered after passing through the mounting hole, thereby effectively improving sensitivity of each regions in the sensing region sensing the detected object. The height of the sensing region is set within a proper range, not only to ensure that a space of the sensing region meets a movement requirement of the detected object, but also to effectively control the height to help dispose a vacant sensing region, thereby reducing false triggering cases.

Preferably, a triggering mechanism includes a button assembly, a side portion of the connecting seat is provided with a through-hole, the button assembly includes a button exposed through the through-hole, and an end surface that is of the button and that is exposed through the through-hole form a force pressing region. The button assembly is a standby triggering manner, and operation stability is ensured by setting two triggering manners.

Preferably, the contactless triggering portion includes a connecting seat and a sound control assembly disposed on the connecting seat, and the sound control assembly receives an external sound source instruction and triggers implementation of a corresponding operation. The sound control assembly controls running of the water dispenser by receiving the external sound source instruction. In this way, not only a user is effectively prevented from directly coming into contact with the water dispenser, but also the user does not need to perform a limb action, thereby improving usage experience.

Preferably, a mounting groove whose groove opening is exposed is disposed on the connecting seat, and the sound control assembly is fixedly embedded into the mounting groove, so that a sound receiving portion of the sound control assembly is exposed through the groove opening. The sound control assembly is fixedly connected to a surface of the housing by using the connecting seat. After being mounted in place, the sound receiving portion is exposed on the surface of the housing, thereby ensuring connection stability of the sound control assembly, ensuring that the sound receiving portion is constantly disposed outwards, and improving accuracy of receiving the sound source instruction.

Preferably, the connecting seat is fixedly mounted on an exposed surface of the housing, so that the contactless triggering portion is exposed to the housing. The contactless triggering portion is configured to control a water outlet status of the water dispenser. When the contactless triggering portion uses different structures, corresponding signal sources are all different. In this way, usage experience is improved by enhancing diversity of signal sources. When the infrared assembly is configured, the detected object is a hand of a user. When the hand of the user enters the sensing region and is sensed by the infrared assembly, the trigger triggers the water dispenser to discharge water, so that the user obtains the drinking water. The sensing region in which the detected object moves is disposed outside the water dispenser, and the sensing region is vacant, to prevent the trigger from being falsely triggered due to presence of a foreign object reflecting infrared rays in the sensing region. When the sound control assembly is configured, the user controls a working status of the water dispenser by saying a preset sound source instruction.

Preferably, the connecting seat is disposed on a top surface of the housing, to form the sensing region above the housing; or a water receiving box is disposed on a front wall of the housing, and the connecting seat is disposed on an inner wall of the water receiving box, to form the sensing region in front of the water receiving box; or a decoration panel is disposed on a front wall of the housing, and the connecting seat is disposed in the decoration panel, to form the sensing region in front of the decoration panel. The trigger is disposed at different positions of the housing, to obtain convenient operation experience.

Preferably, a circuit board is disposed in the housing, an interface is disposed on the contactless triggering portion, and the interface is electrically connected to the circuit board by using a wire. The circuit board is configured to control a running status of the water dispenser. The circuit board is connected to the trigger by using a wire, and obtains an instruction of a user by using the trigger, thereby ensuring control stability, and improving usage experience. An interface is disposed on each of the infrared assembly and the sound control assembly, so that the infrared assembly and the sound control assembly can be separately connected to the circuit board. In this way, the water dispenser can control running of the water dispenser by using the infrared assembly and/or the sound control assembly.

Beneficial effects of the present invention are as follows: The contactless triggering portion that can receive the external instruction at a distance is disposed on the connecting seat, so that a user may control running of the water dispenser at a distance without coming into contact with the water dispenser. The user is prevented from directly coming into contact with the trigger to prevent transmission of bacteria and viruses, and health of the user is ensured by blocking a transmission route of bacteria and viruses, thereby improving usage experience.

### BRIEF DESCRIPTION OF THE DRAWINGS

FIG. 1 is a schematic diagram of a disassembly structure of a contactless triggering portion according to Embodiment 1;

FIG. 2 is a schematic structural diagram of an infrared assembly according to Embodiment 1;

FIG. 3 is a schematic diagram of a circuit assembly structure according to Embodiment 1;

FIG. 4 is a schematic diagram of a circuit assembly structure of a sound control assembly according to Embodiment 2;

FIG. 5 is a schematic diagram of a disassembly structure of a contactless triggering portion according to Embodiment 3; and

FIG. 6 is a schematic diagram of a circuit assembly structure of a contactless triggering portion according to Embodiment 3, where

in the figures, 1. connecting seat; 2. infrared assembly; 3. mounting hole; 4. fixed connecting ring; 5. infrared transmitting piece; 6. infrared receiving piece; 7. shield; 8. sound control assembly; 9. circuit board; 10. water outlet pipe.

### DETAILED DESCRIPTION

Substantive features of the present invention are further described below with reference to the accompanying drawings and specific implementations of the specification.

### Embodiment 1

This embodiment provides a contactless water dispenser.

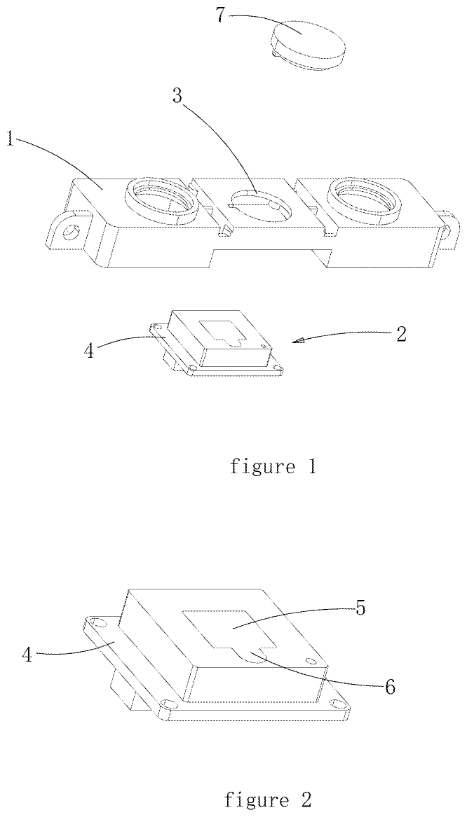

The water dispenser shown in FIG. 1 includes a housing, and a water receiving pipe, a water tank, and a water outlet pipe that are disposed in the housing. The water tank receives external drinking water through the water receiving pipe and performs discharging through the water outlet pipe, and a contactless triggering portion is disposed at a top portion of the housing, so that the contactless triggering portion receives an external instruction at a distance and triggers implementation of a corresponding operation. The contactless triggering portion includes a connecting seat 1 and a triggering mechanism disposed on the connecting seat 1. The triggering mechanism includes an infrared assembly 2 exposed on a top surface of the connecting seat 1, a sensing region corresponding to the infrared assembly 2 is disposed above the connecting seat 1, and the infrared assembly 2 senses a moving path of a detected object in the sensing region and triggers a corresponding operation. The connecting seat 1 is fixedly mounted on an exposed surface of the housing, and a vacant sensing region corresponding to the infrared assembly 2 is formed outside the housing. The infrared assembly 2 that can be triggered at a distance is disposed on the trigger, so that a user may perform water outlet control on the water dispenser by moving a hand in the sensing region, without directly coming into contact with the trigger, thereby not only effectively blocking a transmission route of viruses and bacteria, and ensuring health of the user, but also improving usage experience, and facilitating operations.

During an actual operation, the infrared assembly 2 may sense the moving path of the detected object, to trigger different operation instruction based on the moving path of the detected object. For example, the infrared assembly 2 may sense actions of the detected object moving to the left and backwards in the sensing region, and the actions are respectively used to trigger actions of outputting cold water and outputting hot water, thereby effectively improving usage experience.

During an actual operation, a position for disposing the sensing region is associated with a position for mounting the connecting seat 1. In this way, not only it can be ensured that the sensing region is vacant, to prevent false triggering, but also it can be ensured that a space in the sensing region meets a requirement, to provide sufficient motion space for the detected object, thereby improving detection accuracy. Specifically, the connecting seat 1 is disposed on a top surface of the housing, to form the sensing region above the housing; or a water receiving box is disposed on a front wall of the housing, and the connecting seat 1 is disposed on an inner wall of the water receiving box, to form the sensing region in front of the water receiving box; or a decoration panel is disposed on a front wall of the housing, and the connecting seat 1 is disposed in the decoration panel, to form the sensing region in front of the decoration panel. For the water dispenser, the position for mounting the connecting seat 1 may be selected based on a structure of the water dispenser, to effectively prevent false triggering, and further effectively improve usage experience.

During an actual operation, the infrared assembly 2 is located in the middle of a bottom surface of the sensing region, thereby ensuring performance stability of the infrared assembly 2 detecting each region in the sensing region, and ensuring that the sensing region has a relatively large vacant space, to provide a user with an operation space. Specifically, a height of the sensing region is H, and H=30 cm. In this way, not only design difficulty is reduced by limiting the height of the sensing region, but also sensing sensibility is effectively improved, and further, a sufficient space for swinging a hand is provided for the user. In addition, H may be further 20 cm, 29 cm, 31 cm, 40 cm, or the like, provided that a requirement of 20 cm≤H≤40 cm is met.

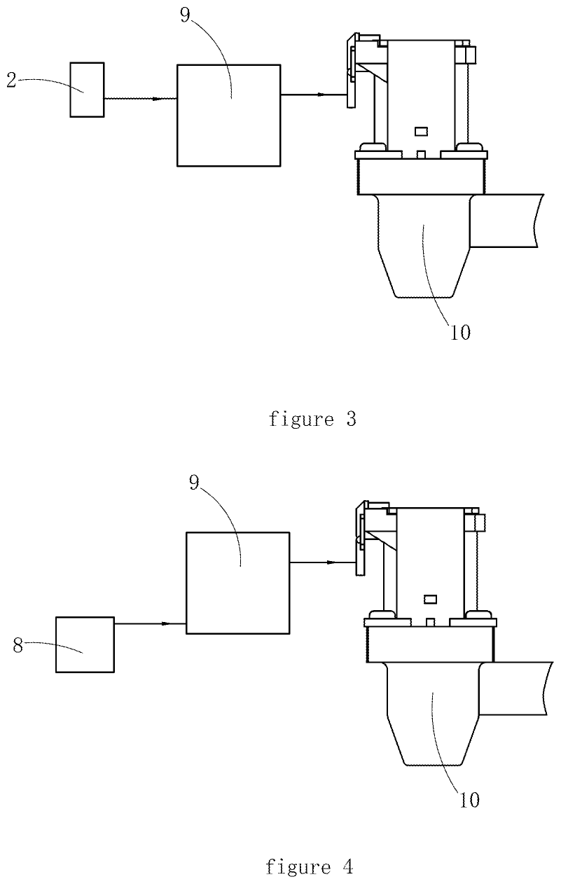

During an actual operation, a circuit board (shown in FIG. 3) is disposed in the housing, an interface is disposed on the infrared assembly 2, and the interface is electrically connected to the circuit board by using a wire. The circuit board learns an instruction of the user by using the infrared assembly 2, to control a valve to open and close, to implement on-demand discharge of drinking water, thereby improving usage experience.

During an actual operation, the connecting seat 1 is provided with a mounting hole 3 that is vertically through, and the infrared assembly 2 is mounted on a bottom surface of the connecting seat 1 from bottom to top and is exposed through the mounting hole 3. The infrared assembly 2 is fixedly inserted into a lower port of the mounting hole 3. After the connecting seat 1 is mounted in place, the infrared assembly 2 is clamped between the housing and the lower port of the mounting hole 3, to prevent the infrared assembly 2 from falling off the mounting hole 3. A through-hole is provided on a periphery of the connecting seat 1, and a fastener passes through the through-hole and is screwed and locked on a preset work position on the housing.

During an actual operation, the infrared assembly 2 includes a fixed connecting ring 4, and after being mounted in place, the fixed connecting ring 4 is lapped from bottom to top on a periphery of the lower port of the mounting hole 3 and is fixedly connected by using a fastener. The fixed connecting ring 4 is fixedly connected on the connecting seat 1 by using at least three fasteners, thereby ensuring a stable connection between the two.

During an actual operation, the infrared assembly 2 includes an infrared transmitting piece 5 and an infrared receiving piece 6 (shown in FIG. 2), infrared rays generated by the infrared transmitting piece 5 passes through the mounting hole 3 and is scattered to the sensing region, and is received by the infrared receiving piece 6 after being reflected by the detected object, so that the infrared assembly 2 is triggered. Both a vertical projection of the infrared transmitting piece 5 and a vertical projection of the infrared receiving piece 6 fall within a vertical projection of the shield 7, thereby ensuring smooth transmission and receiving of the infrared rays.

During an actual operation, an upper port of the mounting hole 3 is covered with a transparent shield 7, and after being mounted in place, the shield 7 covers and blocks the upper port of the mounting hole. The shield 7 not only does not hinder passing of the infrared rays, but also plays a role of isolating a foreign object such as dust.

During an actual operation, a button assembly is disposed on the housing, a side portion of the connecting seat 1 is provided with a through-hole, the button assembly includes a button exposed through the through-hole, and an end surface that is of the button and that is exposed through the through-hole form a force pressing region. A button is disposed to control running of the water dispenser, thereby ensuring that control can still be performed by using the button after the infrared assembly 2 fails, to improve usage experience. In addition, the button assembly may be further independently disposed on the housing, which should also be considered as a specific implementation of this embodiment.

### Embodiment 2

Compared with Embodiment 1, this embodiment provides another structure of a water dispenser.

The water dispenser shown in FIG. 4 includes a housing, and a water receiving pipe, a water tank, and a water outlet pipe that are disposed in the housing. The water tank receives external drinking water through the water receiving pipe and performs discharging through the water outlet pipe, and a contactless triggering portion is disposed at a top portion of the housing, so that the contactless triggering portion receives an external instruction at a distance and triggers implementation of a corresponding operation. The contactless triggering portion includes a connecting seat and a sound control assembly 8 disposed on the connecting seat, and the sound control assembly 8 receives an external sound source instruction and triggers implementation of a corresponding operation.

During an actual operation, the sound control assembly 8 receives a specific sound source instruction to control the water dispenser to perform a corresponding operation. For example, a sound source instruction “power on” is set to power on the water dispenser, and a sound source instruction “discharge” is set to control the water dispenser to discharge drinking water, which should both be considered as specific embodiments of the present invention.

During an actual operation, a mounting groove whose groove opening is exposed is disposed on the connecting seat, and the sound control assembly 8 is fixedly embedded into the mounting groove, so that a sound receiving portion of the sound control assembly 8 is exposed through the groove opening. The connecting seat is fixedly connected on a surface of the housing, and the groove opening of the mounting groove is disposed outwards. During mounting, a bottom portion of the sound control assembly 8 is inserted into the mounting groove and is connected to a circuit board through the interface. After mounting is performed in place, the sound receiving portion of the sound control assembly 8 is exposed to the housing through the groove opening, thereby effectively reducing a loss in a process of transferring the sound source instruction to the sound receiving portion, and improving control accuracy.

Another structure and effects of the water dispenser in this embodiment are consistent with those in Embodiment 1, and are not described herein again.

### Embodiment 3

Compared with Embodiment 1, this embodiment provides another structure of a water dispenser.

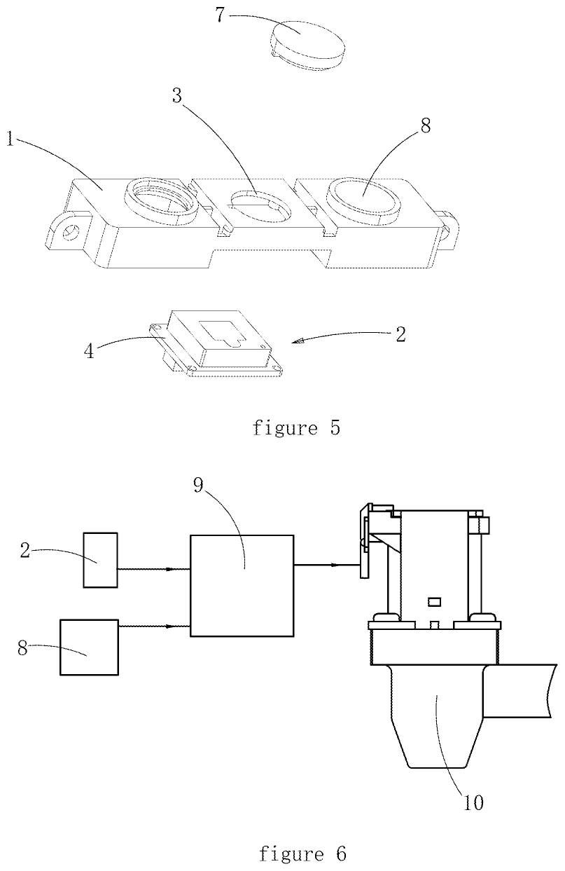

As shown in FIG. 5 and FIG. 6, the contactless triggering portion includes an infrared assembly and a sound control assembly 8. A user triggers, by moving a limb, a manner cooperating with a sound source instruction to control the water dispenser.

During an actual operation, a mixed operation is performed on the water dispenser by using the infrared assembly and the sound control assembly 8. The infrared assembly and the sound control assembly 8 each have advantages and disadvantages. Specifically, the infrared assembly can sense a detected object moving only in a sensing region, so that it is relatively difficult to falsely trigger the infrared assembly, and the infrared assembly has relatively desirable control reliability. The sound control assembly 8 may set a plurality of specific sound source instructions as required, so that the instructions may be diversified, to meet a usage requirement.

During use, first, the water dispenser is triggered for power-on in a first triggering phase, so that the water dispenser is switched from a power-off state to a power-on state; then temperature of drinking water is controlled in a second triggering phase, so that the water dispenser generates drinking water whose temperature meets a drinking requirement; finally, discharging control is performed on the drinking water in a third triggering phase, to quantitatively discharge the drinking water.

In the first triggering phase, infrared triggering is preferably selected. The water dispenser is located in a region in which a user often moves. Therefore, when the user unintentionally says a specific sound source instruction, the water dispenser is falsely triggered, thereby affecting usage experience. However, the user moves a limb in a specific sensing region to trigger the water dispenser to power on, thereby improving usage experience.

In the second triggering phase, because the water dispenser has a relatively large temperature adjustment range, the sound control assembly 8 is preferably selected to adjust temperature of drinking water. Specifically, different temperature instructions are pre-stored to ensure diversity in temperature choices of drinking water for the user, thereby improving usage experience. For example, “95°”, “85°”, “45°”, “25°”, “5°”, and the like are set to freely adjust the temperature of the drinking water within a preset range.

In the third triggering phase, the infrared assembly is preferably selected to control a connection/disconnection state of a water outlet pipe of the water dispenser, thereby not only facilitating operations, but also effectively simplifying the structure. In addition, when the water dispenser has a quantitative discharging function, the sound control assembly 8 is preferably selected to control the connection/disconnection state of the water outlet pipe. Connection duration of the water outlet pipe is controlled, so that the user obtains a preset quantity of drinking water. For example, “15 ml”, “50 ml”, “100 ml”, “200 ml”, and the like are set to discharge the drinking water based on the preset quantity of water, to meet a usage requirement, which should also be considered as a specific implementation of this embodiment.

Another structure and effects of the water dispenser in this embodiment are consistent with those in Embodiment 1, and are not described herein again.

1. A contactless water dispenser, comprising a housing, and a water receiving pipe, a water tank, and a water outlet pipe (10) that are disposed in the housing, wherein the water tank receives external drinking water through the water receiving pipe and performs discharging through the water outlet pipe (10), and a contactless triggering portion is disposed at a top portion of the housing, so that the contactless triggering portion receives an external instruction at a distance and triggers implementation of a corresponding operation.

2. The contactless water dispenser according to claim 1, wherein the contactless triggering portion comprises a connecting seat and an infrared assembly (2) exposed on a top surface of the connecting seat (1), a sensing region corresponding to the infrared assembly (2) is disposed above the connecting seat (1), and the infrared assembly (2) senses a moving path of a detected object in the sensing region and triggers implementation of a corresponding operation.

3. The contactless water dispenser according to claim 2, wherein the connecting seat (1) is provided with a mounting hole (3) that is vertically through, and the infrared assembly (2) is mounted on a bottom surface of the connecting seat (1) from bottom to top and is exposed through the mounting hole (3).

4. The contactless water dispenser according to claim 3, wherein the infrared assembly (2) comprises a fixed connecting ring (4), and after being mounted in place, the fixed connecting ring (4) is lapped from bottom to top on a periphery of a lower port of the mounting hole (3) and is fixedly connected by using a fastener; or an upper port of the mounting hole (3) is covered with a transparent shield (7), and after being mounted in place, the shield (7) covers and blocks the upper port of the mounting hole.

5. The contactless water dispenser according to claim 2, wherein the infrared assembly (2) comprises an infrared transmitting piece (5) and an infrared receiving piece (6), infrared rays generated by the infrared transmitting piece (5) passes through a mounting hole (3) and is scattered to the sensing region, and is received by the infrared receiving piece (6) after being reflected by the detected object, so that the infrared assembly (2) is triggered; or the infrared assembly (2) is located in the middle of a bottom surface of the sensing region, a height of the sensing region is H, and 20 cm≤H≤40 cm; or a button assembly is disposed on the housing, a side portion of the connecting seat (1) is provided with a through-hole, the button assembly comprises a button exposed through the through-hole, and an end surface that is of the button and that is exposed through the through-hole form a force pressing region.

6. The contactless water dispenser according to claim 1, wherein the contactless triggering portion comprises a connecting seat (1) and a sound control assembly (8) disposed on the connecting seat, and the sound control assembly (8) receives an external sound source instruction and triggers implementation of a corresponding operation.

7. The contactless water dispenser according to claim 6, wherein a mounting groove whose groove opening is exposed is disposed on the connecting seat (1), and the sound control assembly (8) is fixedly embedded into the mounting groove, so that a sound receiving portion of the sound control assembly (8) is exposed through the groove opening.

8. The contactless water dispenser according to claim 7, wherein the connecting seat (1) is fixedly mounted on an exposed surface of the housing, so that the contactless triggering portion is exposed to the housing.

9. The contactless water dispenser according to claim 7, wherein the connecting seat (1) is disposed on a top surface of the housing; or a water receiving box is disposed on a front wall of the housing, and the connecting seat (1) is disposed on an inner wall of the water receiving box; or a decoration panel is disposed on a front wall of the housing, and the connecting seat (1) is disposed in the decoration panel.

10. The contactless water dispenser according to claim 7, wherein a circuit board (9) is disposed in the housing, an interface is disposed on the contactless triggering portion, and the interface is electrically connected to the circuit board (9) by using a wire.
